(19) United States
(12) Patent Application Publication
(10) Pub. No.: US 2013/0320249 A1
(43) Pub. Date: Dec. 5, 2013

(54) DONOR TUBE SEALING HEAD WITH NON-TENSION TUBE SUPPORTS

(71) Applicant: FENWAL, INC., Lake Zurich, IL (US)

(72) Inventors: Kwang Suk Kim, Palatine, IL (US); James Darren Roxas, Chicago, IL (US); Terry Chung, Kildeer, IL (US); David Shao Ling, Vernon Hills, IL (US); Daniel Lynn, Spring Grove, IL (US); Richard West, Lake Villa, IL (US); Craig Sandford, Buffalo Grove, IL (US)

(73) Assignee: Fenwal, Inc., Lake Zurich, IL (US)

(21) Appl. No.: 13/765,551

(22) Filed: Feb. 12, 2013

Related U.S. Application Data
(60) Provisional application No. 61/652,707, filed on May 29, 2012.

(51) Int. Cl. F16K 7/00

(52) U.S. Cl. CPC F16K 7/00
USPC 251/4

(57) ABSTRACT

A blood donor tube sealing apparatus includes a housing configured to house an electronic circuit configured to provide a radio frequency signal. The sealing apparatus further includes a sealing device coupled to the housing. The sealing device includes a movable sealing head and at least one movable tube support. The movable sealing head and movable tube support are configured to be moved into contact with a blood donor tube. The movable sealing head is powered by the radio frequency signal to seal the blood donor tube.

### CONTINUITY DATA

The present application claims priority to U.S. Provisional No. 61/652,707 entitled “DONOR TUBE SEALING HEAD WITH NON-TENSION TUBE SUPPORTS,” and filed May 29, 2012, the entirety of which is hereby incorporated by reference.

### BACKGROUND

The present disclosure relates generally to the field of sealing apparatuses for fluid systems. More specifically, the disclosure relates to a sealing apparatus for separating and sealing plastic tubing for handling biological fluids.

In some applications, fluid flowing through conduits or tubing in a system may be divided into separate streams for purposes of collection or further processing. For example, an apheresis machine may use a centrifuge or other blood separation device to separate blood collected from a subject into its constituent components, such as red blood cells, platelets, plasma, or the like. After separation, the apheresis machine may provide the blood components to collection bags or other containers via polymer tubing. Once a collection bag has been filled, it may be separated from the apheresis machine by cutting through the tubing and sealing the ends of the tubing. However, if tension is applied to the tubing during the sealing process (e.g., through inadvertent contact with the tubing on either side of the sealing apparatus), the sealing operation may fail, resulting in an incomplete seal and a leak in the tubing.

### SUMMARY

One embodiment relates to a tube sealing apparatus that includes a body defining an opening configured to receive a length of tubing. The apparatus also includes a movable sealing head located within the opening and configured to apply a radio frequency signal to the tubing to seal the tube. The apparatus further includes one or more movable tube supports that move with the sealing head to contact the tubing such that compressive support is applied to the tubing while the sealing head seals the tube.

Another embodiment relates to a tube sealing apparatus that includes an electronic circuit that generates a radio frequency signal. The apparatus also includes a housing that houses the electronic circuit and a cable connected to the circuit and configured to transmit the radio frequency signal from the circuit. The apparatus further includes a hand unit connected to the cable that receives the radio frequency signal. The hand unit defines an opening configured to receive a length of tubing. The hand unit also includes a movable sealing head located within the opening and configured to seal the tube using the radio frequency signal. The hand unit further includes one or more movable tube supports that move with the sealing head to contact the tubing such that compressive support is applied to the tubing while the sealing head seals the tube.

A further embodiment relates to a tube sealing apparatus that includes sealing means for applying a radio frequency signal to a length of tubing to seal the tubing. The apparatus also includes actuator means for moving the sealing means from a first position to a second position in which the sealing means applies compressive force to the tubing. The apparatus further includes support means for applying compressive support to the tubing while the sealing means seals the tubing.

These embodiments are mentioned not to limit or define the scope of the disclosure, but to provide example implementations of the disclosure to aid in understanding thereof. Particular embodiments may be developed to realize one or more of the following advantages.

### BRIEF DESCRIPTION OF THE DRAWINGS

Features, aspects, and advantages of the present invention will become apparent from the following description, appended claims, and the accompanying exemplary embodiments shown in the drawings, which are briefly described below.

FIG. 1 is a schematic cross section of a sealing head including tube supports in a first position, in accordance with an exemplary embodiment.

FIG. 2 is a schematic cross section of the sealing head of FIG. 1 in a second position.

FIG. 3 is a schematic cross section of a sealing head including tube supports in a first position, in accordance with another exemplary embodiment.

FIG. 4 is a schematic cross section of the sealing head of FIG. 3 in a second position.

FIG. 5 is a perspective view of a tube sealing apparatus, in accordance with an exemplary embodiment.

FIG. 6 is a perspective view of a tube sealing apparatus, in accordance with another exemplary embodiment.

FIG. 7A-7D are schematic cross-section views of a tube sealing apparatus, illustrating a tube-sealing process in accordance with an exemplary embodiment.

FIG. 8 is a perspective view of a tube sealing apparatus, in accordance with another exemplary embodiment.

FIG. 9 illustrates a tube supports which is cooled by way of a non-electrically conductive, but thermally conductive material attached to a cooling heat sink, according to an exemplary embodiment.

Like reference numbers and designations in the various drawings indicate like elements.

### DETAILED DESCRIPTION OF THE PREFERRED EMBODIMENTS

It is to be understood that the following detailed description is exemplary and explanatory only, and is not restrictive of the invention as claimed. One or more embodiments may allow fluids to be approximately equally distributed between x number of finished good containers. One or more embodiments may allow component self regulation of distributing a larger amount of pre-distributed fluid approximately equally into x number of finished good containers without requiring the manual intervention of an operator for burping or redistribution after an automated process has completed. One or more embodiments may save time and increase efficiency in an overall fluid distribution process. One or more embodiments may provide a more consistent distribution of finished processed fluid and allow a wider variety of orientations of bag positioning. One or more embodiments may be altered to allow better ergonomics, packaging or performance.

A fluid system, such as that found in a blood apheresis machine, may be utilized to process whole blood or other suspensions of biological material in a fluid. The system may include conduits or tubing configured to convey fluid through the system to and/or from one or more collection bags or other containers. For example, a blood apheresis machine may provide separated blood components to different collection bags via tubing. In some embodiments, the tubing in the fluid system is formed of non-reactive materials that are suitable for handling biological fluids and may be configured for a single use (e.g., intended to be disposed after each use). The tubing may be formed of a relatively flexible material, such as PVC or silicone, in some embodiments. While described with reference to a blood donor tube used in an apheresis machine, the concepts described herein may be applied to other tubes, with or without solutions, such as transfer packs. Other forms of fluid systems may include, but are not limited to, dialysis machines, medical devices configured to administer a medicament, and other medical devices configured to take a sample of a biological fluid from a subject.

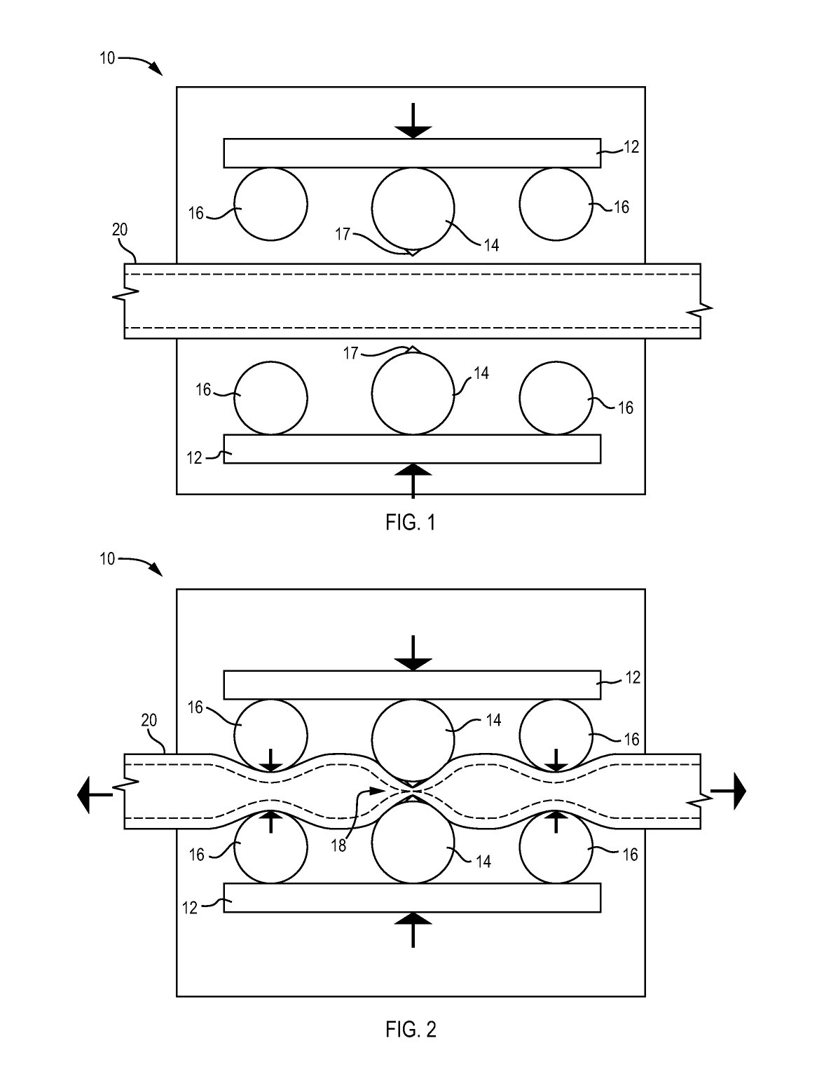

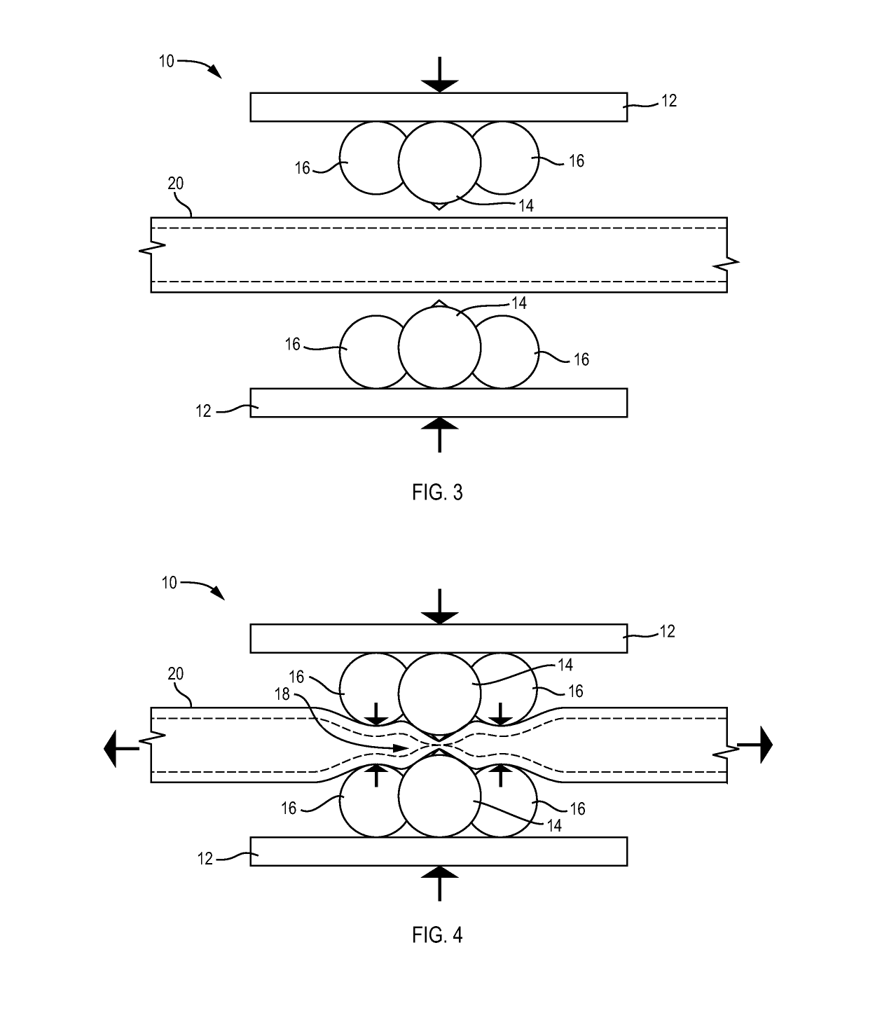

Referring generally to FIGS. 1-4, a sealing device 10 for a sealing apparatus is shown, according to various embodiments. The sealing device 10 is configured to divide (e.g., split, detach, separate, etc.) a length of tubing 20 (e.g., donor tubing, transfer tubing, etc.) and seal the open ends of the tubing 20 to prevent spilling or leaking of the fluid in the tubing 20. The tubing 20 may be divided, for example, to allow a filled blood collection bag containing whole blood or a blood component to be removed from an apheresis machine. FIGS. 1-2 generally demonstrate the sealing device 10 having tube supports 16 that are not in contact with sealing heads 14 in open and closed positions, respectively. FIGS. 3-4 demonstrate an alternate embodiment of the sealing device 10 in which tube supports 16 are in direct contact with sealing heads 14 in open and closed positions, respectively.

According to an exemplary embodiment, the sealing device 10 divides and seals the tubing 20 with a heat seal. The tubing 20 is received between a pair of sealing heads 14 mounted to frames 12 (e.g., as shown in FIGS. 1 and 3). One or both of the frames 12 are articulated, allowing the sealing heads 14 to be moved towards each other, clamping the tubing 20 between the sealing heads 14 (e.g., as shown in FIGS. 2 and 4). The sealing heads 14 are conductive elements that are coupled to an electrical power source, in some embodiments. RF energy may be applied to the sealing heads 14, creating an electrical field that dielectrically heats the compressed tubing 20. The heat welds the material of the tubing 20 together to form a hermetically sealed portion 18, which traps fluid in the tubing 20 and prevents fluid from passing the sealed portion 18. The sealed portion 18 of the tubing 20 may then be cut or otherwise separated (e.g., snapped apart, etc.) without fluid leaking from the tubing 20. In one exemplary embodiment, both of the frames 12 are articulated to compress tubing 20 between the sealing heads 14. In other exemplary embodiments, one of the frames 12 may be articulated while the other frame 12 is stationary, to compress tubing 20 between sealing heads 14.

In various embodiments, each sealing head 14 may include a pointed or sharp heat sealing surface 17 configured to seal tube 20 in such a manner that allows the separated portion of tube 20 to be snapped apart, without the need or use of a separate cutting device. Surfaces 17 may be configured to seal a septum into the tubing to allow this feature of snapping apart.

While the sealing device 10 is described herein as a heat sealing mechanism, in other embodiments, the tubing 20 may be divided and sealed in other suitable manners. For example, the sealing head 14 may be configured to physically crimp the tubing 20 (e.g., by folding the tubing back on itself one or more times and crimping the folded tubing).

During the sealing process, the strength of the tubing 20 may be reduced, leaving it more susceptible to damage. While the compressed portion is being heated, a tension applied to tubing 20 on either side of the sealing device 10 may cause an incomplete weld to form, resulting in a failed seal and a leak in the tubing 20. Such a tension, for example, may result from incidental contact to the tubing 20. For example, a tension of as little as 250 grams-force applied to a typical form of tubing used in a blood or blood component collection system may be sufficient to cause an incomplete weld.

According to an exemplary embodiment, tube supports 16 are provided on either side of one or both of the sealing heads 14. The tube supports 16 are protrusions that apply a compressive force to the tubing 20 to isolate the sealed portion 18 from the portions of the tubing 20 extending outside of the sealing device 10 during the sealing process. Any number of tube supports 16 may be used in sealing device 10 and may be located in any number of positions relative to sealing heads 14. According to an exemplary embodiment, the sealing device 10 includes four tube supports 16, with one tube support 16 on either side of each of the sealing heads 14. In other embodiments, tube supports 16 may be provided on either side of one of the sealing heads 14 and may be configured to compress the tubing 20 against another body, such as the opposing frame 12. In still other embodiments, tube supports 16 may only be provided on one side of the sealing heads 14.

As shown in FIGS. 1-4, in one embodiment, the tube supports 16 are generally cylindrical members having lengths that run substantially perpendicular to the tube 20 being separated. In other embodiments, the tube supports 16 may have another geometry (e.g., ovoid, elliptical, etc.) that applies a sufficient compressive force to hold the tubing 20 and isolate the sealed portion 18 such that any applied tension does not permanently damage or deform the tubing 20. In some embodiments, the tube supports 16 do not completely occlude the tubing 20 and allow a fluid in the tubing 20 to flow away from the sealed portion 18 when the sealing device 10 is fully actuated. Thus, blood or another biologic fluid may be forced away from the sealed ends of tubing 20, preventing spillage or allowing the fluid to escape from the tubing 20.

In some embodiments, the tube supports 16 are formed of a rigid, non-electrically conductive material to resist heat transmission to the tubing 20 on either side of the sealed portion 18. In one exemplary embodiment, the tube supports are formed of a ceramic material. In other embodiments, the tube supports 16 may be a polymer material (e.g., a thermoset plastic, thermoplastic, etc.) such as polyoxymethylene, sold under the trade name Delrin® by DuPont. In some embodiments, tube supports 16 may comprise one or more materials that are electrically non-conductive (e.g., an electrical insulator) and thermally conductive. Tube supports 16 may be cooled by way of a non-electrically conductive, but thermally conductive material attached to a cooling heat sink, such as heat sink 902 shown in FIG. 9. The tube support material can be made from a variety of electrically non-conductive, non RF responsive, yet thermally conductive materials. Such materials may include Cool Poly D from Cool Polymers (coolpolymers.com) and Nemcon H from Ovation Polymers (ovationpolymers.net). Similar materials are available from vendors such as RTP Co., GE Plastics, DuPont, Schulman, LNP and PolyOne. Other methods may be used for purposes of dissipating heat, in other embodiments. For example, ceramic tube support inserts may be used in supports 16 as ceramic is not an electric conductor and may avoid excessive thermal heat-up.

The tube supports 16 may be rigidly mounted, or may be spring mounted to apply a fixed pressure to the tubing 20 and support the tubing 20 from externally applied incidental force during sealing. As shown in FIGS. 1 and 2, in one embodiment, the tube supports 16 may be coupled to the frame members 12 and separated from the sealing heads 14. As shown in FIGS. 3 and 4, in another embodiment, the tube supports 16 may be coupled directly to the sealing heads 14. During operation, one or both of frame members 12 may move between a first position (e.g., an open position) in which compressive force is not applied by sealing heads 14 to tubing 20 and a second position (e.g., a closed position) in which sealing heads 14 apply a compressive force to tubing 20, such as when tubing 20 is being sealed.

The tube supports 16 may be configured to actuate simultaneously with the sealing heads 14. As shown in FIGS. 1-4, during the actuation of the sealing device 10, the tube supports 16 are fixed relative to the sealing heads 14 and may contact the tubing 20 after the sealing heads 14 contact the tubing 20. In other embodiments, the tube supports 16 may be movable relative to the sealing heads 14 (e.g., spring loaded) and may contact the tubing 20 simultaneously with the sealing heads 14 or may contact the tubing 20 before the sealing heads 14 contact the tubing 20. In one embodiment, the device may be configured to actuate the tube clamping/gripping design features (item 16) prior to actuation of the sealing head (item 14). In an embodiment where the actuation of the clamping/gripping design features (item 16) precedes actuation of the sealing head, this action would secure the tube and eliminate any external tension applied to the tube in preparation for the sealing operation (item 14), and may provide improved seal quality.

According to one alternative embodiment, the sealing device designs shown in FIGS. 1-4 need not be symmetric. The sealing device could also be asymmetric in that the tube clamping/gripping design features (e.g., tube supports 16) and the sealing head 14 may be mounted on one side only of the sealing head, and the other side may be a simple flat plate or other surface to seal the tubing between.

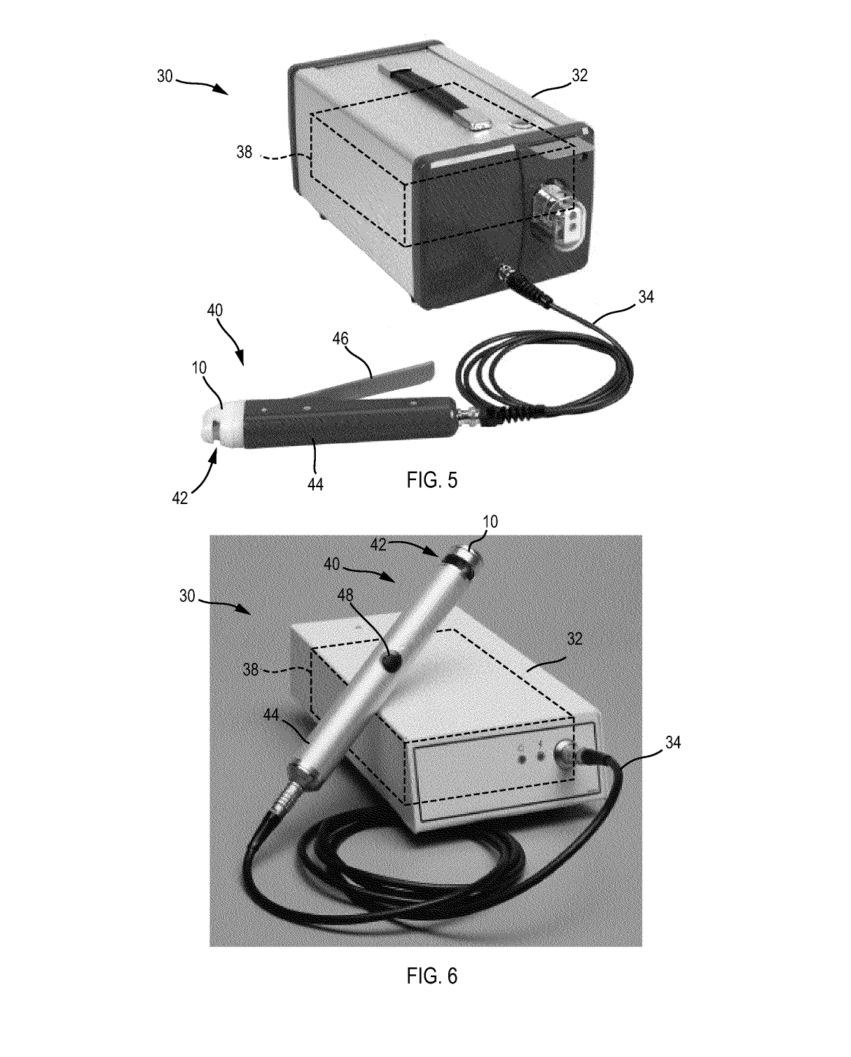

Referring now to FIG. 5, a tube sealing apparatus 30 is shown, according to one embodiment. Sealing apparatus 30 may include sealing device 10, which may be actuated in a variety of ways, in various embodiments. In the embodiment shown, sealing device 10 may be provided as part of sealing apparatus 30 within a manual hand unit 40. The sealing apparatus 30 includes a housing 32 that is coupled to the hand unit 40 with a cable or cord 34, that supplies electrical power to sealing device 10 to weld or otherwise seal a length of tubing. The housing 32 may be a desktop or tabletop unit that receives power from an outlet (e.g., a 110 VAC power source) or may receive power from batteries. The hand unit 40 includes a main body 44 to which the sealing device 10 is coupled. Tubing is inserted between the sealing heads 14 of sealing device 10 through an opening or gap 42. The sealing device 10 may be actuated manually via a handle 46 coupled to the body 44. A user compresses the tubing in the sealing device 10 by squeezing the handle 46 against the main body 44, thereby causing frames 12 of sealing device 10 move towards one another and apply pressure to the inserted tubing.

Referring now to FIG. 6, another exemplary embodiment of a tube sealing apparatus 30 is shown. As shown, hand unit 40 of tube sealing apparatus 30 may instead be automatically actuated in response to input from a user interface 48 (e.g., a button, switch, or the like). For example, depression of interface 48 may cause one or more actuators in sealing unit 10 to provide compressive force to frames 12. As a result, pressure may be exerted onto a tube that has been inserted into gap 42 and a seal may be formed in the tubing. According to further embodiments, tube sealing apparatus 30 may not have a hand unit 40 but instead incorporate sealing device 10 directly into its housing 32. For example, housing 32 may itself include gap 42 and sealing device 10.

The sealing apparatus 30 further includes an electronic circuit 38 coupled to the sealing heads 14. The electronic circuit 38 senses when the sealing heads 14 close, either manually or automatically (e.g., with an electrical, hydraulic, or pneumatic actuator) and provides a radio frequency (RF) signal to the sealing heads 14. The tube supports 16 engage the tubing 20. With the sealing heads 14 and the tube supports 16 closed on the tubing, the electronic circuit 38 measures the change in dielectric constant of the tubing material between the sealing heads 14. The electronic circuit 38 automatically turns off the RF signal if the measured dielectric constant indicates a threshold thickness of the tubing (i.e., the sealed portion 18) or after a predetermined time period (e.g., 1 second). If the sealing heads 14 are automatically actuated, the electrical signal may then withdraw the sealing heads 14. The sealing apparatus 30 may include a visual indicator such as an LED or an audio indicator to inform the user that the sealing process is complete.

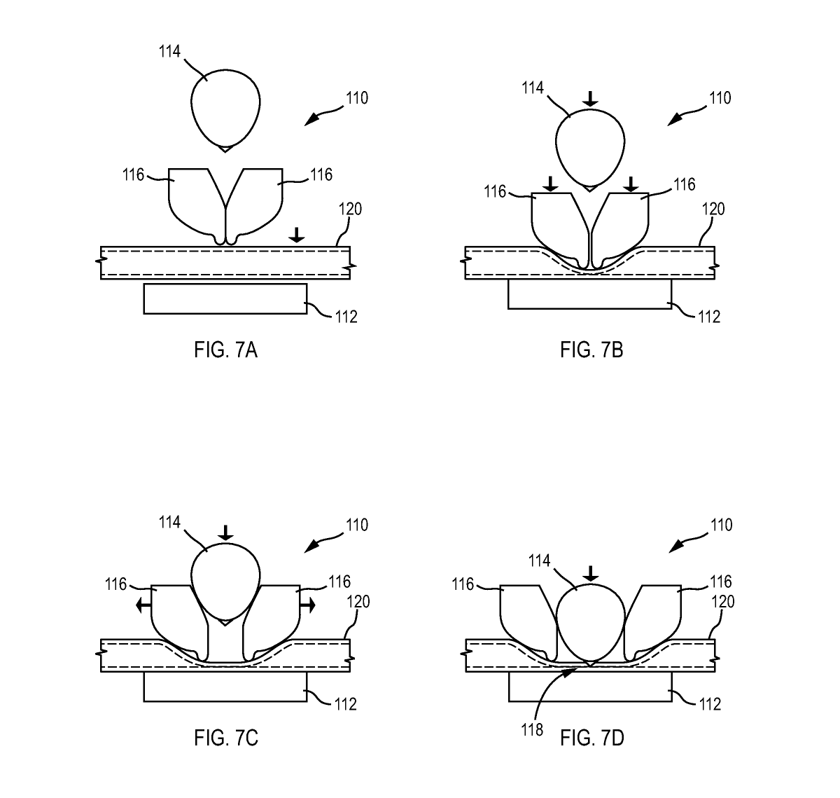

Referring now to FIGS. 7A-7D, a sealing device 110 for a sealing apparatus is shown, according to another exemplary embodiment. The sealing device 110 is configured to divide (e.g., split, detach, separate, etc.) a length of tubing 120 (e.g., donor tubing, transfer tubing, etc.) and seal the open ends of the tubing 120 to prevent spilling or leaking of the fluid in the tubing 120. According to an exemplary embodiment, the sealing device 110 divides and seals the tubing 120 with a heat seal. The tubing 120 is received between a sealing head 114 and a plate 112 (see FIGS. 1 and 3). The sealing head 114 is articulated and can be moved towards the plate 112 clamping the tubing 120 between the sealing head 114 and the plate 112 (see FIGS. 7B-7D). The sealing head 114 and the plate 112 are conductive elements or comprise conductive elements that are coupled to an electrical power source. RF energy is applied to the sealing head 114, creating an electrical field that dielectrically heats the compressed tubing 120. The heat welds the material of the tubing 120 together to form a hermetically sealed portion 118, trapping fluid in the tubing 120 and preventing fluid from passing the sealed portion 118. The sealed portion 118 of the tubing 120 may then be cut or otherwise separated (e.g., snapped apart, etc.) without fluid leaking from the tubing 120.

According to an exemplary embodiment, tube supports 116 (e.g., fixtures, cleaners, etc.) are provided on either side of the sealing head 114. The tube supports 116 are moveable members that apply a compressive force to the tubing 120 to isolate the sealed portion 118 (see FIG. 7D) from the portions of the tubing 120 extending outside of the sealing device 110 during the sealing process. According to an exemplary embodiment, the sealing device 110 includes two tube supports 116, with one tube support 116 on either side of the sealing head 114. The tube supports have a contact end that is round or otherwise shaped to not damage the tubing 120. The tube supports 116 are moveable members that are articulated in a direction transverse to the plate 112 to compress the tubing 120 against the plate 112 during the sealing process. The tube supports are also articulated in a direction parallel to the plate 112 to push blood in the tubing 120 away from the sealing head 114.

At the beginning of the sealing process, the tube 120 is placed in the sealing device 110 between the tube supports 116 and the plate 112, as shown in FIG. 7A. As the sealing process is initiated, the sealing head 114 is moved towards the tubing 120. The tube supports 116 contact the tubing, compressing the tubing 120 against the plate 112 and occluding the tubing 120, as shown in FIG. 7B. Further movement of the sealing head 114 toward the tubing 120 causes the tube supports 116 to move outward, pushing fluid away from the sealing area, as shown in FIG. 7C. The tube supports 116 may be pushed outward directly by the sealing head 114 or may be moved outward by an intermediate device (e.g., a mechanical linkage, a motor, a piston, etc.). The sealing head 114 contacts the tubing 120 and applies an RF energy to weld the material of the tubing 120 together to form a hermetically sealed portion 118, as shown in FIG. 7D. Because the fluid in the tubing 120 is pushed away from the sealed portion 118 by the tube supports 116, the fluid is not exposed to the heat induced by the sealing head 114. For a fluid such as blood, this reduces the likelihood of hemolysis caused by thermoshock to the red blood cells.

The tube sealing system as shown in FIGS. 7A-7D offers the benefit of displacing any solution in the tubing (or greatly minimizing the amount of fluid in the segment of the tubing being sealed). In alternative embodiments, however, there are cases where the blood volume may need to be maintained, such as donor tube segments (for cross-matching purposes). A ½ cc of blood fills each donor tube segment, at a length of 3⅜ inches long (for tubing with 0.118″ ID). To maximize the solution volume in the tube, the clamping/gripping design features (item 16) may be of a narrow design shape to minimize the displacement of solution from the region of the tube to be sealed.

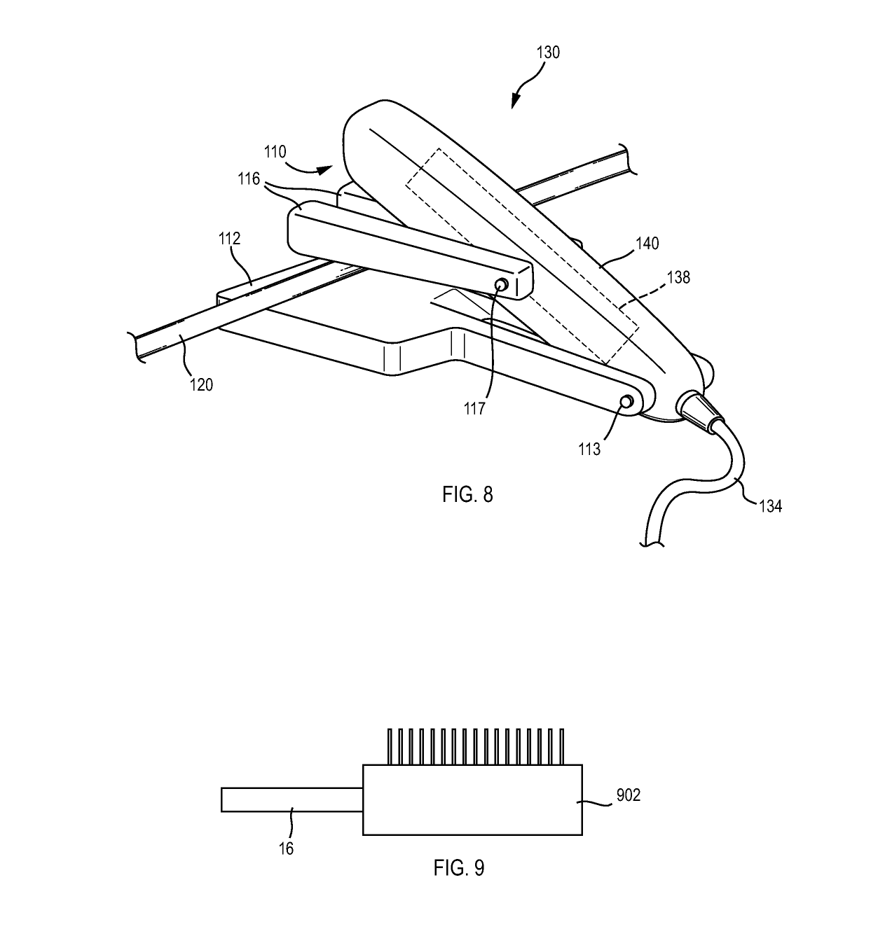

Referring now to FIG. 8, a perspective view of the sealing apparatus 130 is shown, according to an exemplary embodiment. Sealing apparatus 130 includes the sealing device 110, which may have sealing head 114 at the end of a lever 140. The lever 140 is pivotably attached to a rigid frame member such as the plate 112 at a pivot point 113. The tube supports 116 are coupled to the lever 140 at pivot points 117, which allow the tube supports 116 to be moved towards or away from the plate 112 by the movement of the lever 140. The pivot points 117 may be configured to also allow for the lateral movement of the tube supports 116 along the length of the tubing 120. In other embodiments, the tube supports may be resilient members or may be articulated to allow for lateral movement.

The sealing apparatus 130 may be a desktop or tabletop unit that receives power from an outlet (e.g., a 110 VAC power source) through a cable or cord 134 or may receive power from batteries. An electronic circuit 138 coupled to the sealing heads 114 may be contained within the lever 140. In other embodiments, the cord 134 may couple the sealing apparatus 130 to another unit housing the electronic circuit 138.

Tubing 120 is inserted between the tube supports 116 and the plate 112. The sealing device 110 is actuated manually by pushing down on the lever 140. A user compresses the tubing 120 in the sealing device 110 as described above. The tube supports 116 engage the tubing 120 and push fluid in the tubing 120 away from the sealing area. The electronic circuit 138 senses when the sealing head 114 closes and provides a radio frequency (RF) signal to the sealing head 114, thereby causing sealing head 114 to heat up and seal the tubing. With the sealing head 114 and the tube supports 116 closed on the tubing, the electronic circuit 138 measures the change in dielectric constant of the tubing material between the sealing head 114 and the plate 112. The electronic circuit 138 automatically turns off the RF signal if the measured dielectric constant indicates a threshold thickness of the tubing (i.e., the sealed portion 118) or after a predetermined time period (e.g., 1 second). The sealing apparatus 130 may include a visual indicator such as an LED or an audio indicator to inform the user that the sealing process is complete.

Referring now to FIG. 9, an illustration is shown of a tube support 16 which is cooled by a heat sink 900. In some embodiments, tube support 16 may be constructed using non-electrically conductive, but thermally conductive material attached to cooling heat sink 900. Thus, heat generated by sealing head 14 may be dissipated away from the tubing via heat sink 900. Since the tube support 16 is constructed using non-electrically conductive material, electrical power supplied to the sealing head 14 may be localized in the region of the head and not applied to the tubing in the region of the tube supports.

The shapes of the sealing head and the clamping/gripping design features are not limited to the diagrams as shown.

The construction and arrangement of the elements of the sealing apparatus as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. Some like components have been described in the present disclosure using the same reference numerals in different figures. This should not be construed as an implication that these components are identical in all embodiments; various modifications may be made in various different embodiments. It should be noted that the elements and/or assemblies of the enclosure may be constructed from any of a wide variety of materials that provide sufficient strength or durability, in any of a wide variety of colors, textures, and combinations.

What is claimed is:

1. A tube sealing apparatus, comprising:
a body defining an opening configured to receive a length of tubing;
a movable sealing head located within the opening and configured to apply a radio frequency signal to the tubing to seal the tube; and
one or more movable tube supports that move with the sealing head to contact the tubing such that compressive support is applied to the tubing while the sealing head seals the tube.

2. The apparatus of claim 1, wherein the movable tube supports are located on opposing sides of the sealing head.

3. The apparatus of claim 2, wherein the tube supports are in direct contact with the sealing head.

4. The apparatus of claim 1, wherein the one or more tube supports and the sealing head are coupled to a rigid frame member configured to move between an open position and a closed position, wherein the sealing head applies compressive force to the tubing when the frame member is in the closed position.

5. The apparatus of claim 1, wherein the one or more tube supports do not fully occlude the tube when the sealing head seals the tubing.

6. The apparatus of claim 1, wherein the one or more tube supports comprise substantially cylindrical members having lengths that run substantially perpendicular to the tubing when in contact with the tubing.

7. The apparatus of claim 1, further comprising:
a heat sink coupled to one or more tube supports and configured to dissipate heat from the one or more tube supports, wherein the one or more tube supports comprise an electrical insulator that is thermally conductive.

8. The apparatus of claim 1, further comprising:
a plate located in the opening opposite the sealing head, wherein the one or more tube supports are configured to articulate in a direction transverse to the plate to compress the tubing against the plate, and wherein the one or more tube supports are configured to articulate in a direction parallel to the plate to push a fluid in the tubing away from the sealing head.

9. A tube sealing apparatus comprising:
an electronic circuit that generates a radio frequency signal;
a housing that houses the electronic circuit;
a cable connected to the circuit and configured to transmit the radio frequency signal from the circuit;
a hand unit connected to the cable that receives the radio frequency signal, wherein the hand unit defines an opening configured to receive a length of tubing, wherein the hand unit further comprises a movable sealing head located within the opening and configured to seal the tube using the radio frequency signal, and wherein the hand unit comprises one or more movable tube supports that move with the sealing head to contact the tubing such that compressive support is applied to the tubing while the sealing head seals the tube.

10. The apparatus of claim 9, wherein the movable tube supports are located on opposing sides of the sealing head.

11. The apparatus of claim 10, wherein the tube supports are in direct contact with the sealing head.

12. The apparatus of claim 9, wherein the one or more tube supports and the sealing head are coupled to a rigid frame member configured to move between an open position and a closed position, wherein the sealing head applies compressive force to the tubing when the frame member is in the closed position.

13. The apparatus of claim 12, wherein the hand unit further comprises a handle pivotally connected to the frame member and configured to move the frame member between the open position and the closed position when pivoting.

14. The apparatus of claim 12, further comprising:
a user interface comprising a button or a switch, wherein the hand unit is configured to move the sealing head in response to input received via the user interface.

15. The apparatus of claim 9, wherein the one or more tube supports comprise substantially cylindrical members having lengths that run substantially perpendicular to the tubing when in contact with the tubing.

16. The apparatus of claim 9, further comprising:
a plate located in the opening opposite the sealing head, wherein the one or more tube supports are configured to articulate in a direction transverse to the plate to compress the tubing against the plate, and wherein the one or more tube supports are configured to articulate in a direction parallel to the plate to push a fluid in the tubing away from the sealing head prior to the tube being sealed by the sealing head.

17. The apparatus of claim 9, further comprising:
a heat sink coupled to one or more tube supports and configured to dissipate heat from the one or more tube supports, wherein the one or more tube supports comprise an electrical insulator that is thermally conductive.

18. A tube sealing apparatus comprising:
sealing means for applying a radio frequency signal to a length of tubing to seal the tubing;
actuator means for moving the sealing means from a first position to a second position in which the sealing means applies compressive force to the tubing; and
support means for applying compressive support to the tubing while the sealing means seals the tubing.

19. The apparatus of claim 18, further comprising:
means for pushing a fluid in the tubing away from the sealing means.

20. The apparatus of claim 19, further comprising:
means for dissipating heat from the support means.
